(19) United States
(12) Patent Application Publication
(10) Pub. No.: US 2022/0329161 A1
(43) Pub. Date: Oct. 13, 2022

(54) EFFICIENCY TRACKING METHOD OF A CONTROLLER APPLIED TO A FLYBACK POWER CONVERTER

(71) Applicant: Leadtrend Technology Corp., Hsinchu County (TW)

(72) Inventors: Ming-Chang Tsou, Hsinchu County (TW); Cheng-Tsung Ho, Hsinchu County (TW); Yuan-Chih Lan, Hsinchu County (TW)

(73) Assignee: Leadtrend Technology Corp., Hsinchu County (TW)

(21) Appl. No.: 17/531,791

(22) Filed: Nov. 21, 2021

Related U.S. Application Data
(60) Provisional application No. 63/172,103, filed on Apr. 8, 2021.

(51) Int. Cl. H02M 3/335; H02M 1/00

(52) U.S. Cl. CPC H02M 3/335; H02M 1/0009

(57) ABSTRACT

An efficiency tracking method of a controller applied to a flyback power converter includes before the controller soft starts, an original frequency variation curve setting voltage generated by the controller outputting an original frequency variation curve setting detection current to an original frequency variation curve setting detection resistor determining a frequency variation curve of the flyback power converter, and utilizing adjustment of resistance of the original frequency variation curve setting detection resistor to achieve efficiency optimization. Therefore, the controller controls an output voltage of the flyback power converter and tracks a maximum power point of the flyback power converter according to the efficiency tracking method to achieve efficiency optimization.

### CROSS REFERENCE TO RELATED APPLICATIONS

This application claims the benefit of U.S. Provisional Application No. 63/172,103, filed on Apr. 8, 2021 and entitled “AI Efficiency tacking of Flyback PWM Controller”, the contents of which are incorporated herein by reference.

### BACKGROUND OF THE INVENTION

### 1. Field of the Invention

The present invention relates to an efficiency tracking method of a controller applied to a power converter, and particularly to an efficiency tracking method that can improve conversion efficiency of the power converter with an output voltage of the power converter accordingly.

### 2. Description of the Prior Art

In the prior art, a Universal Serial Bus (USB) type C power delivery adapter system 10 (as shown in FIG. 1) can provide different charging conditions to various consumer electronic products through a power converter (not shown in FIG. 1) included in the power delivery adapter system 10. For example, as shown in FIG. 1, the power delivery adapter system 10 can provide 20V voltage and 5 A current to charge a liquid crystal display 12, provide 5V voltage and 1 A current to charge a smart phone 14, and provide 5V voltage and 2 A current to charge a tablet computer 16. That is to say, a secondary side of the power converter needs to output different charging conditions (e.g. 20V/5 A, 5V/1 A, 5V/2 A) to various consumer electronic products. Because a user needs to adjust a current detection resistor applied to a primary side of the power converter to change a current corresponding to original frequency variation curve setting detection of the power converter accordingly according to the different charging conditions outputted by the secondary side of the power converter, but the power converter may have lower conversion efficiency, for the user, how to avoid adjusting the current detection resistor to respond to the different charging conditions has become an important issue.

### SUMMARY OF THE INVENTION

An embodiment of the present invention provides an efficiency tracking method of a controller applied to a flyback power converter. The efficiency tracking method includes the controller outputting an original frequency variation curve setting detection current to an original frequency variation curve setting detection resistor before the controller soft starts; the controller shifting a current frequency variation curve to a next frequency variation curve according to an original frequency variation curve setting voltage determined by the original frequency variation curve setting detection current and the original frequency variation curve setting detection resistor; the controller controlling operation of the flyback power converter according to the next frequency variation curve.

Another embodiment of the present invention provides an efficiency tracking method of a controller applied to a flyback power converter. The efficiency tracking method includes detecting a current input voltage, a current input current, a current output voltage, and a current output current of the flyback power converter; obtaining current input power according to the current input voltage and the current input current, and obtaining current output power according to the current output voltage and the current output current; obtaining a current efficiency ratio according to the current output power and the current input power; fine tuning the current output voltage to make a next efficiency ratio close to a maximum power point tracking (MPPT) according to the current efficiency ratio, a previous efficiency ratio, the current output voltage, and a previous output voltage.

The present invention provides an efficiency tracking method of a controller applied to a flyback power converter. The efficiency tracking method utilizes a controller shifting a current frequency variation curve to a next frequency variation curve according to an original frequency variation curve setting voltage determined by an original frequency variation curve setting detection current and an original frequency variation curve setting detection resistor, and then the controller controlling operation of the flyback power converter according to the next frequency variation curve, or utilizes fine tuning a current output voltage to make an efficiency ratio determined by output power and input power of the flyback power converter close to a maximum power point tracking. Therefore, compared to the prior art, because the present invention does not adjust a current detection resistor applied to a primary side of the power converter, the efficiency tracking method provided by the present invention can still make the output power of a secondary side of the power converter be optimized when the secondary side of the power converter outputs different charging condition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the Universal Serial Bus power delivery adapter system providing different charging conditions to various consumer electronic products.

FIG. 2 is a diagram illustrating a controller applied to a power converter according to a first embodiment of the present invention.

FIG. 3 is a flowchart illustrating an efficiency tracking method of a controller applied to a power converter according to a second embodiment of the present invention.

FIG. 4 is a diagram illustrating a relationship between a frequency of a gate control signal and a compensation voltage.

FIG. 5 is a flowchart illustrating an efficiency tracking method of a controller applied to a power converter according to a third embodiment of the present invention.

FIGS. 6-9 are diagrams illustrating a relationship between an efficiency ratio and an output voltage.

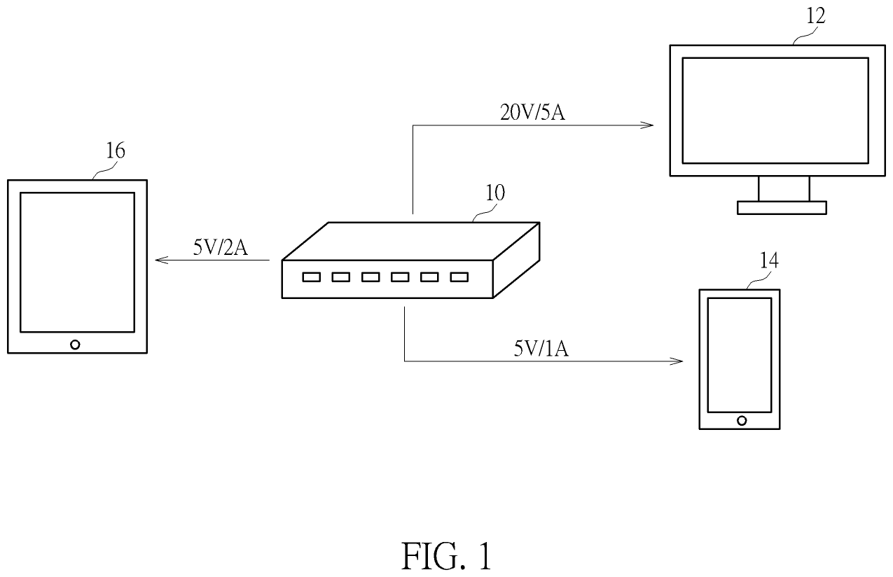

### DETAILED DESCRIPTION

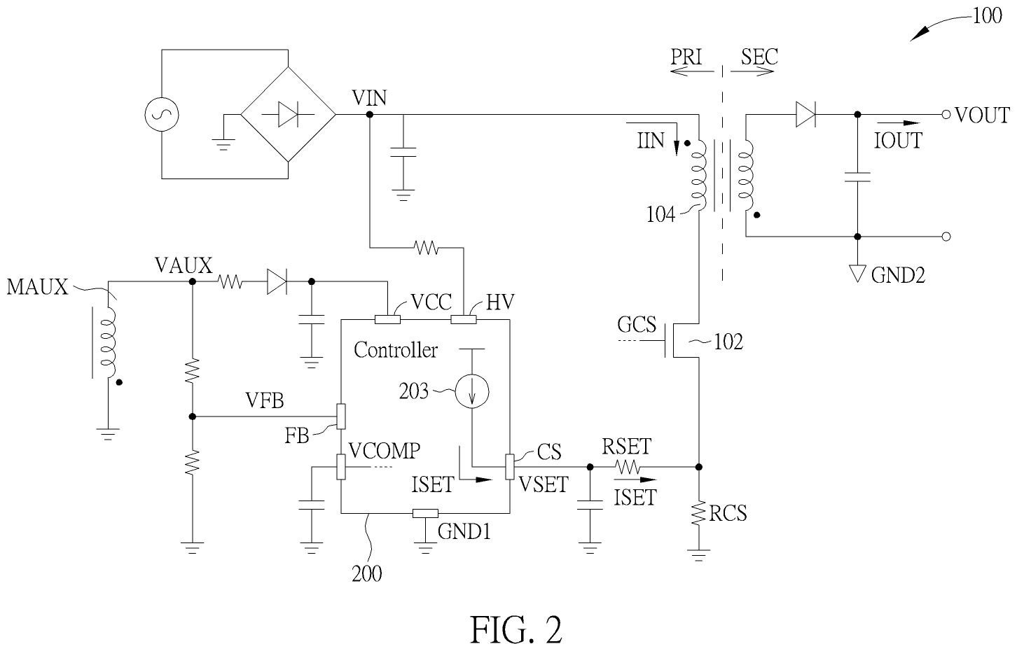

Please refer to FIG. 2. FIG. 2 is a diagram illustrating a controller 200 applied to a power converter 100 according to a first embodiment of the present invention, wherein as shown in FIG. 2, the power converter 100 is applied to a Universal Serial Bus (USB) type C power delivery adapter system (wherein the USB type C power delivery adapter system is not shown in FIG. 2), the power converter 100 is a flyback power converter, the controller 200 is applied to a primary side PRI of the power converter 100, and the controller 200 is a pulse width modulation (PWM) controller. In addition, FIG. 2 only shows components relating to the present invention, and ground potential GND1 of the primary side PRI of the power converter 100 can be the same as or different from ground potential GND2 of a secondary side SEC of the power converter 100.

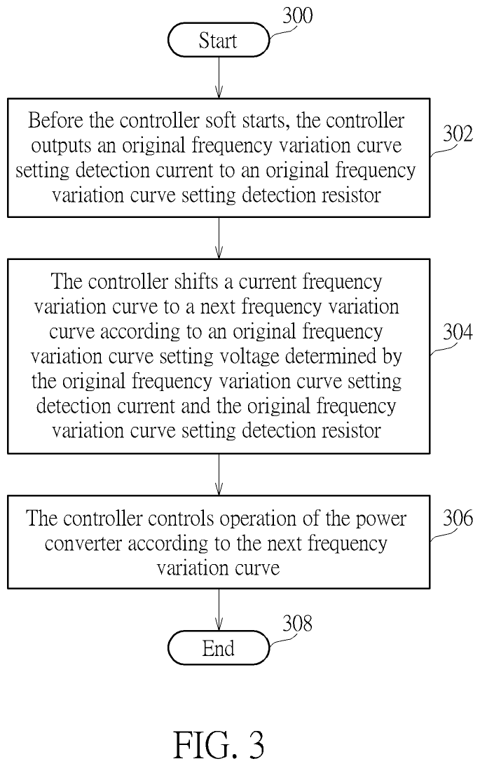

Please refer to FIG. 3. FIG. 3 is a flowchart illustrating an efficiency tracking method of a controller applied to a power converter according to a second embodiment of the present invention. The efficiency tracking method in FIG. 3 is illustrated using the power converter 100 and the controller 200 in FIG. 2. Detailed steps are as follows:

Step 300: Start.

Step 302: Before the controller 200 soft starts, the controller 200 outputs an original frequency variation curve setting detection current ISET to an original frequency variation curve setting detection resistor RSET.

Step 304: The controller 200 shifts a current frequency variation curve L to a next frequency variation curve according to an original frequency variation curve setting voltage VSET determined by the original frequency variation curve setting detection current ISET and the original frequency variation curve setting detection resistor RSET.

Step 306: The controller 200 controls operation of the power converter 100 according to the next frequency variation curve.

Step 308: End.

In Step 302, as shown in FIG. 2, the controller 200 outputs the original frequency variation curve setting detection current ISET through a current detection pin CS to the original frequency variation curve setting detection resistor RSET outside the controller 200 only before the controller 200 soft starts, wherein the original frequency variation curve setting detection current ISET is provided by a current source 203 inside the controller 200, the original frequency variation curve setting detection current ISET is a fixed current, and the original frequency variation curve setting detection resistor RSET can be adjusted by a user.

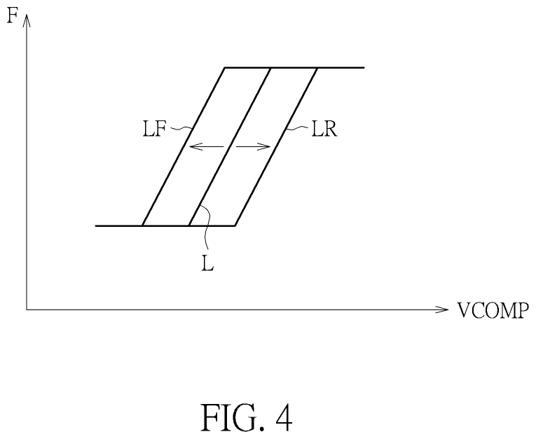

In Step 304, as shown in FIG. 2, the original frequency variation curve setting detection current ISET, the original frequency variation curve setting detection resistor RSET, and a current detection resistor RCS applied to the primary side PRI of the power converter 100 can determine the original frequency variation curve setting voltage VSET, wherein because the original frequency variation curve setting detection current ISET is a fixed current, and the current detection resistor RCS is fixed, the original frequency variation curve setting voltage VSET is changed with the original frequency variation curve setting detection resistor RSET. In addition, as shown in FIG. 4, the controller 200 can shift the current frequency variation curve L to the next frequency variation curve according to the original frequency variation curve setting voltage VSET, wherein the current frequency variation curve L is used for illustrating a relationship between a frequency F (that is, an operating frequency of the power converter 100) of a gate control signal GCS for controlling a power switch 102 and a compensation voltage VCOMP, and the compensation voltage VCOMP relates to an output voltage VOUT of the secondary side SEC of the power converter 100. In addition, if the user of the power converter 100 increases the original frequency variation curve setting detection resistor RSET, the original frequency variation curve setting voltage VSET is increased accordingly, resulting in the controller 200 shifting the current frequency variation curve L toward the right to a frequency variation curve LR; if the user of the power converter 100 reduces the original frequency variation curve setting detection resistor RSET, the original frequency variation curve setting voltage VSET is reduced, resulting in the controller 200 shifting the current frequency variation curve L toward the left to a frequency variation curve LF. In addition, each original frequency variation curve setting voltage VSET corresponds to an original frequency variation curve setting detection ratio, that is to say, the controller 200 can utilize the original frequency variation curve setting detection resistor RSET to change the original frequency variation curve setting voltage VSET, and further to change a current corresponding to original frequency variation curve setting detection of the power converter 100, wherein when the original frequency variation curve setting voltage VSET is increased, the original frequency variation curve setting detection ratio is reduced; and when the original frequency variation curve setting voltage VSET is reduced, the original frequency variation curve setting detection ratio is increased.

In Step 306, the controller 200 can control the operation of the power converter 100 to make output efficiency of the power converter 100 be optimized to meet the requirements of the user according to the next frequency variation curve (e.g. the frequency variation curve LR and the frequency variation curve LF). That is to say, the user can control the operation of the power converter 100 to make the output efficiency of the power converter 100 be optimized by changing the original frequency variation curve setting detection resistor RSET.

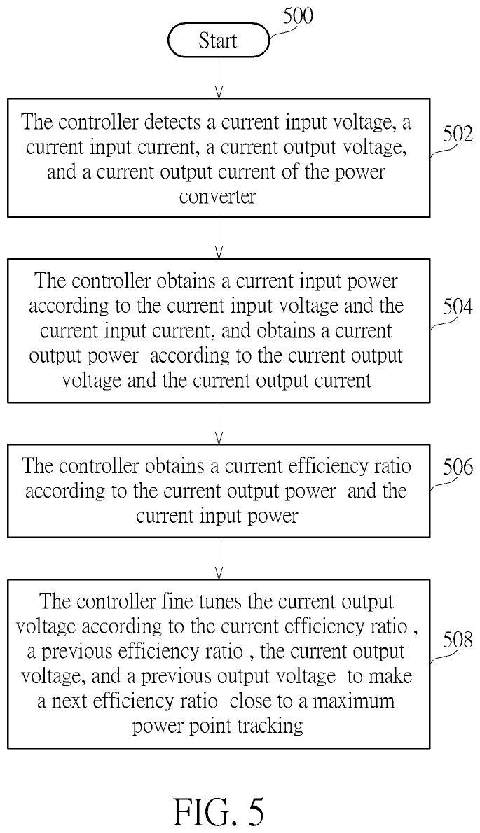

Please refer to FIG. 5. FIG. 5 is a flowchart illustrating an efficiency tracking method of a controller applied to a power converter according to a third embodiment of the present invention. The efficiency tracking method in FIG. 5 is illustrated using the power converter 100 and the controller 200 in FIG. 2. Detailed steps are as follows:

Step 500: Start.

Step 502: The controller 200 detects a current input voltage VIN(n), a current input current IIN(n), a current output voltage VOUT(n), and a current output current IOUT(n) of the power converter 100.

Step 504: The controller 200 obtains a current input power PIN(n) according to the current input voltage VIN(n) and the current input current IIN(n), and obtains a current output power POUT(n) according to the current output voltage VOUT(n) and the current output current IOUT(n).

Step 506: The controller 200 obtains a current efficiency ratio E(n) according to the current output power POUT(n) and the current input power PIN(n).

Step 508: The controller 200 fine tunes the current output voltage VOUT(n) according to the current efficiency ratio E(n), a previous efficiency ratio E(n−1) , the current output voltage VOUT(n), and a previous output voltage VOUT(n−1) to make a next efficiency ratio E(n+1) close to a maximum power point tracking (MPPT), go to Step 502.

In Step 502, as shown in FIG. 2 (in the third embodiment of the present invention, the controller 200 does not include the current source 203, but in another embodiment of the present invention, the controller 200 can include the current source 203), the controller 200 detects the current output voltage VOUT(n) and the previous output voltage VOUT(n−1) through an auxiliary winding NAUX and a feedback pin FB. That is to say, because a voltage VFB of the feedback pin FB corresponds to an auxiliary voltage VAUX of the auxiliary winding NAUX of the primary side PRI of the power converter 100, and the auxiliary voltage VAUX corresponds to the output voltage VOUT of the secondary side SEC of the power converter 100, the controller 200 can detect the current output voltage VOUT(n) and the previous output voltage VOUT(n−1) through the auxiliary winding NAUX and the feedback pin FB, wherein (n) represents current time, (n−1) represents previous time, and the previous time is before the current time. In addition, as shown in FIG. 2, the controller 200 can detect the current input current IIN(n) through the current detection pin CS, and detect the current input voltage VIN(n) through a high voltage pin HV, wherein one of ordinary skilled in the art should know that the current output current IOUT(n) can be calculated according to the current input current IIN(n) and a duty cycle of the gate control signal GCS. In addition, as shown in FIG. 2, the controller 200 can receives a supply voltage further through a supply voltage pin VCC, wherein the supply voltage corresponds to the auxiliary voltage VAUX.

In Step 504 and Step 506, after the controller 200 obtains the current input power PIN(n) and the current output power POUT(n), the controller 200 can obtain the current efficiency ratio E(n) according to the current output power POUT(n), the current input power PIN(n), and equation (1):

$$E ( n ) = \frac{P O U T ( n )}{P I N ( n )} \qquad ( 1 )$$

In Step 508, the controller 200 can fine tune the current output voltage VOUT(n) according to the current efficiency ratio E(n), the previous efficiency ratio E(n−1) , the current output voltage VOUT(n), and the previous output voltage VOUT(n−1) to make the next efficiency ratio E(n+1) close to the maximum power point tracking MPPT, wherein the previous efficiency ratio E(n−1) is obtained according to a previous output power POUT(n−1) and a previous input power PIN(n−1), the next efficiency ratio E(n+1) is obtained according to a next output power POUT(n+1) and a next input power PIN(n+1), (n+1) represents next time, and the current time is before the next time. In addition, the current input power PIN(n) can also be represented by equation (2):

PIN(n)=½×L×IIN(n)²×F(n) (2)

In equation (2), F(n) is a current operating frequency of the power converter 100, and L is an inductance of a primary side winding 104 of the primary side PRI of the power converter 100. In addition, equation (3) can be obtained by substituting equation (2) into equation (1):

$$E ( n ) = \frac{V O U T ( n ) \times I O U T ( n )}{\frac{1}{2} \times L \times I I {N ( n )}^{2} \times F ( n )} \qquad ( 3 )$$

As shown in equation (3), because fine tuning the current operating frequency F(n) of the power converter 100 can change the current efficiency ratio E(n), but also change the current output voltage VOUT(n), in the third embodiment of the present invention, the controller 200 can change the current output voltage VOUT(n) to change the current efficiency ratio E(n) to the next efficiency ratio E(n+1).

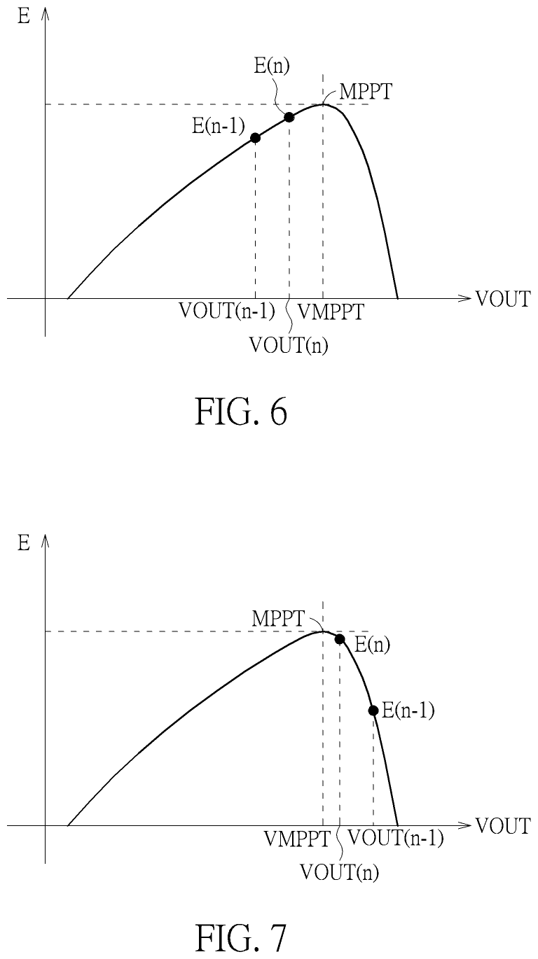

Please refer to FIGS. 6-9. FIGS. 6-9 are diagrams illustrating a relationship between an efficiency ratio and an output voltage. As shown in FIG. 6, when the current efficiency ratio E(n) is greater than the previous efficiency ratio E(n−1) and the current output voltage VOUT(n) is greater than the previous output voltage VOUT(n−1), it means that the current output voltage VOUT(n) and the previous output voltage VOUT(n−1) are located at the left of a voltage VMPPT corresponding to the maximum power point tracking MPPT, so the controller 200 can increase the current output voltage VOUT(n) to make the next efficiency ratio E(n+1) close to the maximum power point tracking MPPT.

As shown in FIG. 7, when the current efficiency ratio E(n) is greater than previous efficiency ratio E(n−1) and the current output voltage VOUT(n) is less than previous output voltage VOUT(n−1), it means that the current output voltage VOUT(n) and the previous output voltage VOUT(n−1) are located at the right of the voltage VMPPT, so the controller 200 can reduce the current output voltage VOUT(n) to make the next efficiency ratio E(n+1) close to the maximum power point tracking MPPT.

As shown in FIG. 8, when the current efficiency ratio E(n) is less than the previous efficiency ratio E(n−1) and the current output voltage VOUT(n) is greater than the previous output voltage VOUT(n−1), it means that the current output voltage VOUT(n) is located at the right of the voltage VMPPT and the previous output voltage VOUT(n−1) is located at the left of the voltage VMPPT, so the controller 200 can reduce the current output voltage VOUT(n) to make the next efficiency ratio E(n+1) close to the maximum power point tracking MPPT.

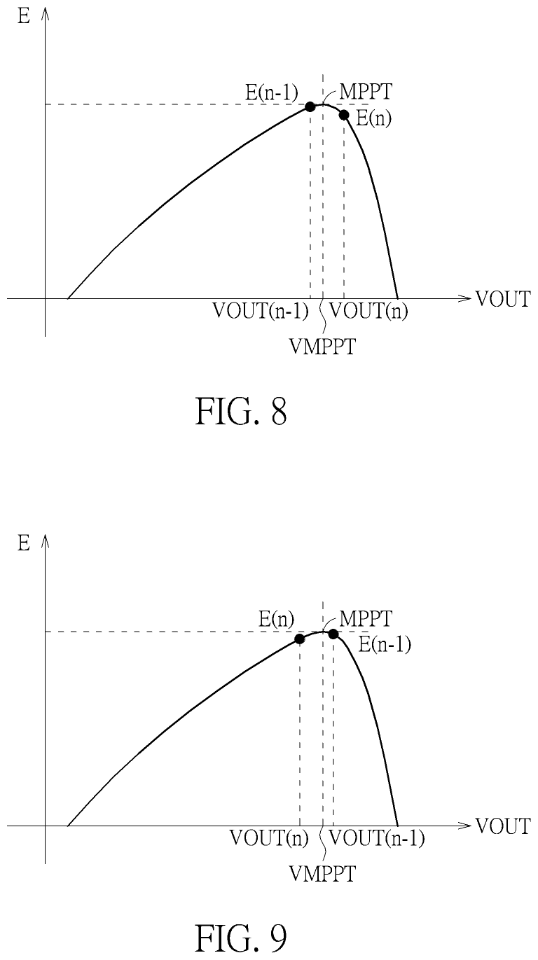

As shown in FIG. 9, when the current efficiency ratio E(n) is less than previous efficiency ratio E(n−1) and the current output voltage VOUT(n) is less than previous output voltage VOUT(n−1), it means that the current output voltage VOUT(n) is located at the left of the voltage VMPPT and the previous output voltage VOUT(n−1) is located at the right of the voltage VMPPT, so the controller 200 can increase the current output voltage VOUT(n) to make the next efficiency ratio E(n+1) close to the maximum power point tracking MPPT.

To sum up, the efficiency tracking method utilizes the controller shifting the current frequency variation curve to the next frequency variation curve according to the original frequency variation curve setting voltage determined by the original frequency variation curve setting detection current and the original frequency variation curve setting detection resistor, and then the controller controlling the operation of the power converter according to the next frequency variation curve, or utilizes fine tuning the current output voltage to make efficiency ratio determined by output power and input power of the power converter close to the maximum power point tracking. Therefore, compared to the prior art, because the present invention does not adjust the current detection resistor applied to the primary side of the power converter, the efficiency tracking method provided by the present invention can still make the output power of the secondary side of the power converter be optimized when the secondary side of the power converter outputs different charging conditions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An efficiency tracking method of a controller applied to a flyback power converter, the efficiency tracking method comprising:
the controller outputting an original frequency variation curve setting detection current to an original frequency variation curve setting detection resistor before the controller soft starts;
the controller shifting a current frequency variation curve to a next frequency variation curve according to an original frequency variation curve setting voltage determined by the original frequency variation curve setting detection current and the original frequency variation curve setting detection resistor; and
the controller controlling operation of the flyback power converter according to the next frequency variation curve.

2. The efficiency tracking method of claim 1, wherein the controller is applied to a primary side of the flyback power converter, and the controller is a pulse width modulation (PWM) controller.

3. The efficiency tracking method of claim 1, wherein the original frequency variation curve setting voltage further corresponds to an original frequency variation curve setting detection ratio.

4. The efficiency tracking method of claim 1, wherein the controller outputs the original frequency variation curve setting detection current through a current detection pin.

5. The efficiency tracking method of claim 1, wherein the current frequency variation curve relates to an operating frequency of the flyback power converter and a compensation voltage, and the compensation voltage relates to an output voltage of a secondary side of the flyback power converter.

6. An efficiency tracking method of a controller applied to a flyback power converter, the efficiency tracking method comprising:
detecting a current input voltage, a current input current, a current output voltage, and a current output current of the flyback power converter;
obtaining current input power according to the current input voltage and the current input current, and obtaining current output power according to the current output voltage and the current output current;
obtaining a current efficiency ratio according to the current output power and the current input power; and
fine tuning the current output voltage to make a next efficiency ratio close to a maximum power point tracking (MPPT) according to the current efficiency ratio, a previous efficiency ratio, the current output voltage, and a previous output voltage.

7. The efficiency tracking method of claim 6, wherein the previous efficiency ratio is obtained according to previous output power and previous input power, the next efficiency ratio is obtained according to next output power and next input power, the previous efficiency ratio, the previous output power, and the previous input power correspond to previous time, the current efficiency ratio, the current output power, and the current input power correspond to current time, the next efficiency ratio, the next output power, and the next input power correspond to next time, the previous time is before the current time, and the current time is before the next time.

8. The efficiency tracking method of claim 6, wherein when the current efficiency ratio is greater than the previous efficiency ratio and the current output voltage is greater than the previous output voltage, the current output voltage is increased.

9. The efficiency tracking method of claim 6, wherein when the current efficiency ratio is greater than the previous efficiency ratio and the current output voltage is less than the previous output voltage, the current output voltage is reduced.

10. The efficiency tracking method of claim 6, wherein when the current efficiency ratio is less than he previous efficiency ratio and the current output voltage is greater than the previous output voltage, the current output voltage is reduced.

11. The efficiency tracking method of claim 6, wherein when the current efficiency ratio is less than the previous efficiency ratio and the current output voltage is less than the previous output voltage, the current output voltage is increased.

12. The efficiency tracking method of claim 6, wherein the controller detects the current output voltage and the previous output voltage through an auxiliary winding and a feedback pin, the controller detects the current input current through a current detection pin, and the controller detects the current input voltage through a high voltage pin.
